(19) United States
(12) Patent Application Publication
(10) Pub. No.: US 2024/0282905 A1
(43) Pub. Date: Aug. 22, 2024

(54) METHOD OF FABRICATING DRY ELECTRODE

(71) Applicants: Hyundai Motor Company, Seoul (KR); Kia Corporation, Seoul (KR)

(72) Inventors: Hyun Jin KIM, Dalseo-gu (KR); Geun Ho CHOI, Suwon-si (KR); Han Nah SONG, Ansan-si (KR)

(21) Appl. No.: 18/359,620

(22) Filed: Jul. 26, 2023

(30) Foreign Application Priority Data
Feb. 17, 2023 (KR) 1020230021097

(51) Int. Cl. H01M 4/04; H01M 4/36; H01M 10/0525

(52) U.S. Cl. CPC H01M 4/0416; H01M 4/364; H01M 10/0525

(57) ABSTRACT

Disclosed is a method of fabricating a dry electrode of a battery. The method includes preparing a mixture of electrode materials by mixing an electrode active material, a conductive material, and a binder in a predetermined ratio, obtaining a flow index of the mixture based on a measurement of flow properties, and determining characteristics of the mixture based on the flow index.

### CROSS-REFERENCE TO RELATED APPLICATION

This application claims under 35 U.S.C. § 119(a) the benefit of priority to Korean Patent Application No. 10-2023-0021097 filed on Feb. 17, 2023, the entire contents of which are incorporated herein by reference.

### TECHNICAL FIELD

The present disclosure relates to a dry electrode of a battery. More particularly, it relates to a method of fabricating a dry electrode of a battery.

### BACKGROUND

Recently, much research on development of secondary batteries having high energy density has been taking place, in particular to keep pace with the rapid growth of the electric vehicle market.

Electrodes of secondary batteries have generally been manufactured through a wet process. In a typical wet process, a slurry can be prepared by dissolving, in a solvent, an electrode substance, a binder, and a conductive material, which are included in an electrode. However, a dry process may also be possible. The dry process may increase the energy density of a battery compared to the wet process without using a solvent required in the wet process.

In the dry process of an electrode, after a mixture of electrode materials is manufactured by mixing the electrode materials, a dry electrode film can be formed from the mixture through a pressing or calendaring method. Fabrication of the electrode can be completed by bonding the formed dry electrode film to a current collector.

Because dry electrode manufacturing is at early stages of technical development, technology related to quality evaluation is not prevalent. Particularly, in order to secure the quality of the fabricated electrode, evaluation technology that can evaluate the quality of the mixture prior to formation of the dry electrode film is required in terms of time, cost, etc.

The above information disclosed in this Background section is only for enhancement of understanding of the background of the disclosure. Therefore, it may contain information that does not form the prior art that is already known to a person of ordinary skill in the art.

### SUMMARY OF THE DISCLOSURE

The present disclosure has been made in an effort to address the above-described problems associated with the prior art, and it is an object of the present disclosure to provide a method of fabricating a dry electrode which may effectively control and manage the quality of a half-finished product during a dry electrode fabrication process.

In one aspect, the present disclosure provides a method of fabricating a dry electrode, including preparing a mixture of electrode materials by mixing an electrode active material, a conductive material, and a binder in a certain ratio, obtaining a flow index of the mixture based on a measurement of flow properties, and predicting characteristics of the mixture based on the flow index.

Other aspects and preferred implementations of the disclosure are discussed infra.

The above and other features of the disclosure are discussed infra.

### BRIEF DESCRIPTION OF THE DRAWINGS

The above and other features of the present disclosure will now be described in detail with reference to certain exemplary implementations thereof illustrated in the accompanying drawings which are given hereinbelow by way of illustration only, and thus are not limitative of the present disclosure, and wherein:

FIG. 1 is a flowchart representing of an example method of fabricating a dry electrode according to the present disclosure;

FIG. 2 is a schematic view illustrating an example test using an exemplary tester of flow properties according to the present disclosure;

FIG. 3 is a flowchart representing an example process marked with A shown in FIG. 1;

FIG. 4 is a photograph showing an example powder mixture of electrode materials, which is capable of being formed into a film, displayed on the left, and a powder mixture of electrode materials which is incapable of being formed into a film, displayed on the right;

FIG. 5A is a photograph showing a dry electrode film formed from the powder mixture, displayed on the left in FIG. 4, by a film formation process;

FIG. 5B is a photograph showing the powder mixture displayed on the right in FIG. 4, which remains powdery even after the film formation process;

FIG. 6 is a graph representing example measurement results of flow indexes of Sample Group 1 and Sample Group 2; and

FIGS. 7A and 7B are graphs representing exemplary electrochemical test results of a dry electrode for batteries fabricated by the method according to the present disclosure.

It should be understood that the appended drawings are not necessarily to scale, and may denote a simplified representation of various preferred features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

Specific structural or functional descriptions in implementations of the present disclosure set forth in the description which follows will be exemplarily given to describe the implementations of the present disclosure, and the present disclosure may be embodied in many alternative forms. Further, it will be understood that the present disclosure should not be construed as being limited to the implementations set forth herein, and the implementations of the present disclosure are provided only to completely disclose the disclosure and cover modifications, equivalents or alternatives which come within the scope and technical range of the disclosure.

In the following description of the implementations, terms, such as “first” and “second,” are used only to describe various elements, and these elements should not be construed as being limited by these terms. These terms are used only to distinguish one element from other elements. For example, a first element described hereinafter may be termed a second element, and similarly, a second element described hereinafter may be termed a first element, without departing from the scope of the disclosure.

Hereinafter, the present disclosure will be described in detail with reference to the accompanying drawings.

Fabricating a dry electrode of a secondary battery contrasts with fabricating a wet electrode. In the dry process, a dry electrode film is formed from a mixture prepared by mixing electrode material powders without a solvent, and an electrode is fabricated by bonding the dry electrode film to a current collector.

In some cases, the quality of the mixture may be checked after subsequent processes are completed.

An electron microscope is generally used to obtain information on the mixture where it is difficult to immediately provide feedback to a process line. Therefore, the present disclosure is intended to provide a method of fabricating a dry electrode which may provide immediate feedback and quality control during a dry electrode fabrication process. According to the present disclosure, the fabricated dry electrode may be a cathode, or may be an anode.

In one example of implementation of the present disclosure, the electrode may include electrode materials and a current collector. The electrode materials may include an electrode active material, a conductive material, and a binder. The method according to the present disclosure may be applied not only to an electrode of a lithium ion battery including a liquid electrolyte but also to an electrode of an all-solid-state battery including a solid electrolyte. According to one example of implementation of the present disclosure, the former, i.e., the electrode of the lithium ion battery, may include 90 to 99 wt % (weight percent) of the electrode active material, 0.01 to 5 wt % of the conductive material, and 0.01 to 5 wt % of the binder. According to another example of the implementation of the present disclosure, the latter, i.e., the electrode of the all-solid-state battery, may include 70 to 99 wt % of the electrode active material, 0.01 to 30 wt % of the solid electrolyte, 0.01 to 5 wt % of the conductive material, and 0.01 to 5 wt % of the binder.

In some examples of implementation, a cathode is fabricated. The electrode active material of the cathode includes a cathode active material. As one non-limiting example, the cathode active material may include lithium nickel manganese cobalt oxide (NMC), lithium ferro-phosphate (LFP), lithium cobalt oxide (LCO), or sulfur.

In some examples of implementation, an anode is manufactured. The electrode active material of the anode includes an anode active material. As a non-limiting example, the anode active material may include graphite or silicon.

The conductive material may include a carbon-based material. Further, when a dry electrode mixture for all-solid-state batteries is manufactured, the electrode materials may include a polyethylene oxide (PEO)-based polymer, an oxide-based solid electrolyte, or a sulfide-based solid electrolyte.

The binder may include a material having a C—F bond, which is a compound of carbon and fluorine, such as polytetrafluoroethylene (PTFE) or polyvinylidene fluoride (PVDF), or styrene butadiene rubber (SBR).

The current collector is bonded to or laminated with the dry electrode film formed from the electrode materials (i.e., the mixture thereof) through film formation. In some examples of implementation, for a cathode, the current collector may include aluminum foil. In some examples of implementation, for an anode, the current collector may include copper foil.

According to one implementation of the present disclosure, the method may include a mixing operation, an evaluation operation, a film formation operation, and a lamination operation.

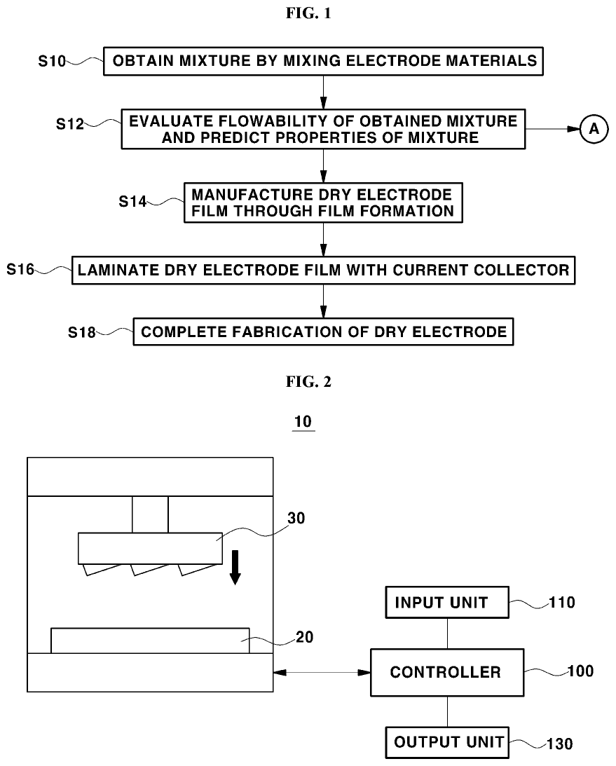

Referring to FIG. 1, at S10, the mixture of the electrode materials is obtained by mixing the electrode materials. The electrode materials may pass through various mixing processes depending on a purpose of dispersion. For example, the electrode materials may be mixed by a process which is fit for the purpose, such as a process using a low shear or high shear mixer, a jet milling machine, a granulator, a resonant acoustic mixer, or the like. When the electrode materials are mixed, setting conditions of the above equipment may be included in mixing conditions which will be described below.

According to one example of implementation of the present disclosure, when an apparatus used in the mixing process is a mixer, such as a low shear or high shear mixer, a resonant acoustic mixer, or the like, the setting conditions or the mixing conditions may include a mixing time (e.g., a unit of hours (h)), a mixing temperature (e.g., a unit of Celsius (° C.)), and a mixing speed (e.g., a unit of meters per second (m/s)). Further, the setting conditions or the mixing conditions may further include a gap (e.g., a unit of millimeters (mm)) between a chamber and blades of the mixer. Moreover, a certain combination of the setting conditions may be the mixing conditions. In some cases, mixing of the electrode materials may be performed not only under a single condition, but also under a combination of a series of setting conditions. For example, the electrode materials may be mixed under conditions, i.e., at a temperature of 40° C. and a speed of 25 m/s for a time of 10 minutes (min), and thereafter, the mixture may be cooled under conditions, i.e., at a temperature of 10° C. and a speed of 5 m/s for a time of 20 mins.

According to another example of implementation of the present disclosure, when a jet milling machine is used in the mixing process, the setting conditions or the mixing conditions may include a pressure (e.g., in a unit of bar) and a mixing time (e.g., in a unit of hour (h)).

According to yet another example of implementation of the present disclosure, when a granulator is used in the mixing process, the setting conditions or the mixing conditions may include a rotating speed (for example, the unit is m/s) and a mesh size (for example, the unit is micrometer (μm)). Here, a mesh indicates a mesh of the granulator through which granulated particles pass. In some examples of implementation of the present disclosure, a chiller configured to control heat generated during mixing may be provided. The chiller may have an operating temperature range of −20 to 20° C. Preparation of a half-finished product or the mixture of the electrode materials, which is capable of being formed into a dry electrode, is completed through the mixing process.

In forming the dry electrode film from the mixture of the electrode materials, it is important to uniformly disperse and compound the electrode materials during the mixing process. For example, when the electrode materials do not pass through the uniform dispersion and compounding process, the electrode film may be torn due to incapability to connect particles of the electrode materials at which the binder is scarce during the film formation process. Further, for example, even though the film is formed, the characteristics of the electrode may become non-uniform and large deviations may occur when the formed film is used to fabricate an electrode because the ratio of the electrode materials is not uniform. Therefore, the present disclosure is intended to evaluate flow properties of the mixture prior to the film formation process to secure uniform dispersion and compounding of the electrode materials. Particularly, in the present disclosure, the evaluation operation is performed before the film formation operation, which allows a prediction about whether the mixture is capable of being properly formed into an electrode film before fabrication of the electrode. Thereby, time and cost may be greatly reduced in fabrication of the dry electrode.

At S12, an evaluation of flow properties of the obtained mixture is performed. As one non-limiting example, the evaluation method which is employed may be executed based on American Society for Testing and Materials (ASTM) standard D6128. Under this evaluation method, a shear stress is applied to a designated amount of the mixture of the electrode materials, and the internal force of the mixture in an equilibrium state or in a steady state flow is measured. The internal force of the mixture in the equilibrium state may indicate distribution of force varied depending on friction and cohesion between particles in the mixture, and a flow index of the mixture may be quantified based on such measurement.

The evaluation of flow properties may be executed based on ASTM standard D6128, as below. For example, a mixture for cathodes may be taken into consideration. The mixture is obtained by putting a cathode active material, such as NMC811 or NMC622, graphite, a binder, etc., into a mixer, and setting mixing conditions, such as a mixing time (h), a mixing temperature (° C.), a mixing speed (m/s), and a gap (mm) between a mixing chamber and blades. Here, the mixture may be obtained through the mixing process under a single mixing condition or a plurality of mixing conditions, as described above. Thereafter, an analysis on the flow properties of the mixture is performed.

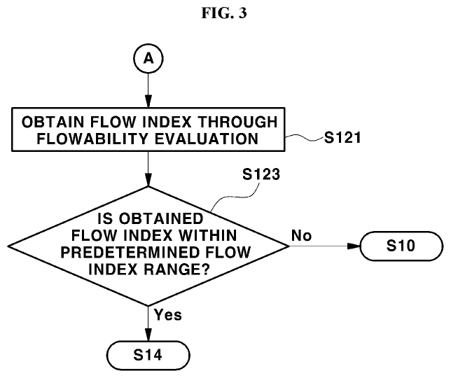

Referring to FIG. 2, the mixture in a powder form is put in a tray 20 of a tester 10 of flow properties of powder. The powder mixture is uniformly spread out by a rotary tool that is separable from the tester 10. Here, the weight of the flattened powder mixture is measured. The measured weight is transmitted to a controller 100 of the tester 10 configured to control the operation of the tester 10. The controller 100 may calculate the density of the mixture based on the measured weight.

Thereafter, when the tester 10 is operated, the flow properties of the mixture is measured. Operation of the tester 10 may be started by an input through an input unit 110 configured to communicate with the tester 10. When the controller 100 receives an operation request through the input unit 110, the controller 100 operates a blade 30 located above the tray 20. The blade 30 is lowered toward the tray 20 by a command from the controller 100 and contacts the powder mixture in the tray 20. The blade 30 applies minute shear stress to the powder mixture by applying minute pressure to the powder mixture, from the moment that the blade 30 contacts with the powder mixture. A collapse may occur in the powder mixture at a certain point in time depending on the characteristics of the powder mixture, and a stress at this point in time may be measured as internal force data and may be output through an output unit 130. When the collapse occurs, a shear stress is applied to the powder mixture by applying a slightly higher pressure to the powder mixture, and internal force data is measured again. According to the present disclosure, the flow index of the powder mixture is obtained by differentiating the measured internal force data with respect to the shear stress.

Particularly, the flow index obtained using the method of evaluating flow properties is varied depending on a ratio of the electrode materials, i.e., the electrode active material, the conductive material, and the binder, in the mixture. Further, the flow index of the mixture, in which the electrode materials are mixed in the same ratio, is varied depending on the degree of mixing of the electrode materials or the mixing conditions. For example, when the binder or the conductive material is non-uniformly dispersed and is thus concentrated in a specific area, shear force applied to this area of the mixture is insufficient or excessive, the degree of compounding of the mixture may be varied. Therefore, when degrees of dispersion and compounding of the mixture under conditions in which the dry electrode film may be formed are detected, a difference in flow indexes may be determined from a mixture having a different degree of mixing of the electrode materials.

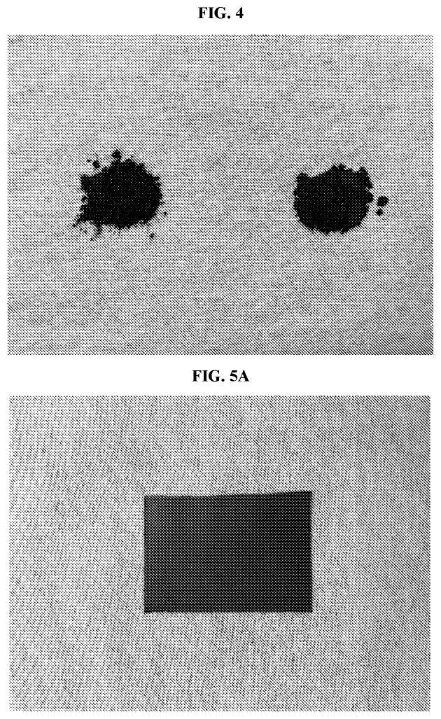

Therefore, the quality or properties of the manufactured mixture may be predicted through the method of evaluating flow properties. As shown in FIG. 3, the flow index of the mixture of the electrode materials is obtained through The method of evaluating flow properties at S121, as shown in FIG. 3. Further, the properties of the manufactured mixture of the electrode materials may be predicted based on the flow index. Here, the properties of the mixture of the electrode materials may include a possibility of forming a film during the film formation process.

It is determined whether the obtained flow index of the corresponding mixture is within a predetermined flow index range at S123. According to the present disclosure, the predetermined flow index becomes a reference in evaluation of the flow properties of the mixture. In some cases, when the mixture which is subject to the evaluation of flow properties has the predetermined flow index, it may be predicted that the mixture will be formed into a normal film through the film formation process. The predetermined flow index range can be set in consideration of an error. When the mixture has a flow index within the predetermined flow index range, it may be predicted that the mixture will be formed into a normal film through the film formation process.

The predetermined flow index may be first set through changes in a composition ratio of the electrode materials, mixing conditions, etc. For example, various mixtures are manufactured by varying the ratio (weight ratio) of the electrode materials or the mixing conditions, such as the degree of mixing of the electrode materials or a mixing method. Then the internal forces of the respective manufactured mixtures are measured using the above-described tester 10. Thereafter, the respective mixtures pass through the film formation process. Among the mixtures, some mixtures may be formed into films, while some other mixtures may not be formed into films. It may be confirmed that the flow indexes of the films formed from some mixtures converge on a specific flow index. In the present disclosure, when an arbitrary mixture has the specific flow index, it may be determined that the mixture is successively formed into a film. For example, although a mixture having a specific composition ratio is manufactured by mixing electrode materials under any mixing conditions, when the measured flow index of the mixture is within a certain range (including an error) of a predetermined flow index corresponding to such a composition ratio, it may be determined that the mixture is capable of being formed into a film.

As a non-limiting example for understanding, it is assumed that a certain mixture A includes 98 wt % of an electrode active material, 1 wt % of a conductive material, and 1 wt % of a binder. Further, it is assumed that a predetermined flow index obtained from mixtures having the same composition ratio is x. In addition, it is assumed that equipment M1 and equipment M2 are provided as equipment configured to mix electrode materials. When the flow index of the mixture is measured as a value of x±d (d being a standard deviation or an error) even though the mixture is obtained by mixing the electrode materials using the equipment M1 or the equipment M2, it may be determined that the mixture A is capable of being formed into a film during the film formation process.

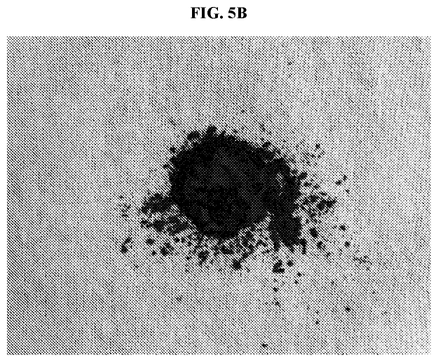

Referring to FIG. 4, this will be described in more detail. First, two mixture samples were prepared. The mixture sample displayed on the left in FIG. 4 corresponds to a sample which is confirmed as being capable of being formed into a film through tests (the composition ratio and the mixing conditions of the same are already known), and the mixture sample displayed on the right in FIG. 4 corresponds to a sample which is confirmed as being incapable of being formed into a film (the composition ratio and the mixing conditions of the same are already known).

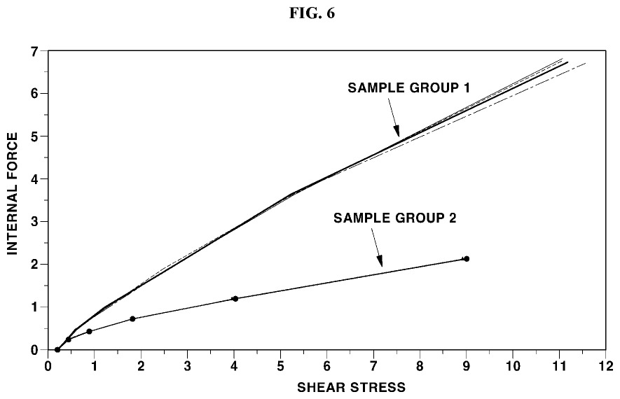

It was confirmed that, in the film formation process, the mixture displayed on the left in FIG. 4 was formed into a dry electrode film, i.e., a free-standing electrode film (with reference to FIG. 5A), but the mixture displayed on the right in FIG. 4 was not formed into a dry electrode film even after a pressing or calendaring process using heat and pressure, and maintained the powder form (with reference to FIG. 5B).

Four mixture samples belonging to Sample Group 1, which are capable of being formed into films, as shown in FIG. 5A, and four mixture samples belonging to Sample Group 2, which are incapable of being formed into films, as shown in FIG. 5B, were manufactured. Thereafter, the flow indexes of the respective samples were measured.

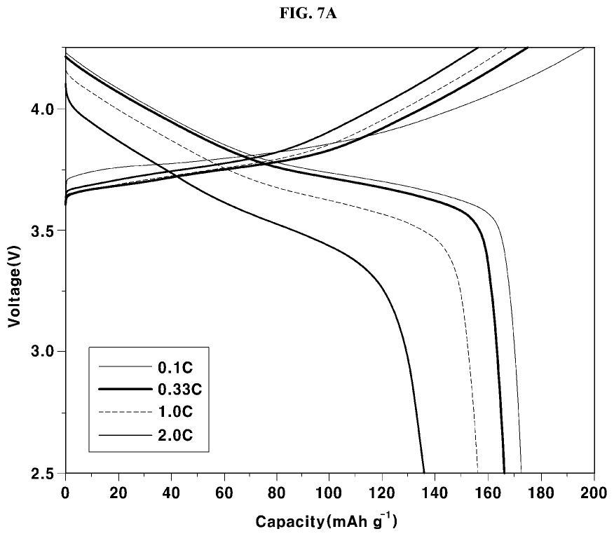

As shown in FIG. 6, as measurement results of the flow indexes of Sample Group 1 and Sample Group 2, it was confirmed that four tests performed under the same conditions exhibited straight lines having similar gradients at almost identical positions.

Table 1 show the quantified results of the graph of FIG. 6. A shear stress was applied to a fixed amount of the mixture or powder of each of the samples belonging to each Sample Group, and the internal force of the mixture or powder of each sample in the equilibrium state was measured. In each line on the graph, the gradient of a linear function obtained by fitting data in all sections of the applied shear stress through linear regression analysis was expressed as a fitted value. Since a flow index is a differential value with respect to a particular shear stress, the fitted value is used to include average information throughout all sections. In some cases, the data may be fitted through non-linear regression. Herein, a differential value at a particular shear stress will be defined as a flow index, and a stress at such a flow index will be defined as flow stress. Although the measured flow index may be changed to a different value depending on the purpose of the dry electrode, it was confirmed that mixtures manufactured through a process controlled under the same conditions exhibit similar flow indexes, and a standard deviation of the measured flow indexes is within 0.02.

TABLE 1

| Sample No. | Fitted value | Flow index |
|---|---|---|
| Sample #1 of Sample Group 1 | 0.60 | 0.61 |
| Sample #2 of Sample Group 1 | 0.58 | 0.59 |
| Sample #3 of Sample Group 1 | 0.61 | 0.62 |
| Sample #4 of Sample Group 1 | 0.61 | 0.62 |
| Sample #1 of Sample Group 2 | 0.22 | 0.21 |
| Sample #2 of Sample Group 2 | 0.22 | 0.21 |
| Sample #3 of Sample Group 2 | 0.22 | 0.21 |
| Sample #4 of Sample Group 2 | 0.22 | 0.21 |

The flow indexes set forth in Table 1 indicate values when the flow stress is 10 kilopascals (kPa). It was confirmed that the average value of the flow indexes of the mixtures belonging to Sample Group 1, which are capable of being formed into films, is 0.61, and the standard deviation of the flow indexes is 0.014. It was confirmed that the average value of the flow indexes of the mixtures belonging to Sample Group 2, which are incapable of being formed into films, is 0.21, and the standard deviation of the flow indexes is 0. Based on the results, it may be confirmed that powder mixtures manufactured under the same process conditions exhibit excellent reproducibility in evaluation of flow properties.

When the flow index of a certain mixture having the same composition ratio is measured as 0.61, it may be predicted that the mixture is manufactured under the same process conditions as the mixtures which are capable of being formed into film. Therefore, samples, research and development of which and verification of the mass-production process of which were completed, exhibit similar flow indexes, and thus, the quality of the samples on processing lines may be easily controlled.

In the same manner as FIG. 6 and Table 1, several mixtures having a specific composition ratio, which are manufactured under different mixing conditions, were prepared. The flow indexes of the respective mixtures were obtained based on the measurement results of flow properties of the mixtures. Further, it was observed whether the respective mixtures are formed into films by performing the film formation process on the respective mixtures. Consequently, the inventors of the present disclosure confirmed that, although the mixing conditions (i.e., a ratio among electrode materials, dispersion conditions, etc.,) are different, the electrode mixture is capable of being formed into a film when the flow index of an electrode mixture for cathodes is 0.50 to 0.70 and the flow index of an electrode mixture for anodes is 0.60 to 0.80. In this way, in the present disclosure, whether the electrode mixture is capable of being formed into a film may be determined in advance prior to the film formation process among the fabrication processes of the dry electrode, thereby being capable of reducing quality control cost and time and improving the quality of the fabricated dry electrode.

More specifically, referring to Table 2, data regarding the flow indexes of cathode mixtures having different ratios among electrode materials and manufactured under different dispersion conditions and data regarding whether the cathode mixtures are capable of being formed into films were obtained.

It may be confirmed from Test Examples 1 to 11 that the cathode mixtures which are capable of being formed into films have flow indexes which are greatly increased compared to those of the cathode mixtures which are incapable of being formed into films (from about 0.2 to about 0.6). The data show that, when the measured flow index of a specific cathode mixture is within the range of 0.50 to 0.70 even though the mixture has any combination of a ratio among electrode materials and dispersion conditions, the cathode mixture is capable of being formed into a film.

It may be confirmed that the flow index of the cathode mixture tends to come close to the range of 0.50 to 0.70 as the dispersion speed (RPM) of mixing equipment increases regardless of the ratio among electrode materials of the cathode mixture, but the possibility of film formation, which is unrecognizable due to subtle changes in the electrode materials, may be determined by the flow index. That is, the cathode mixtures according to Test Examples 3 to 5 have the same dispersion speed and the same ratio of the electrode materials but use different binders, the cathode mixtures according to Test Examples 3 and 5 were formed into films. However, the cathode mixture according to Test Example 4 was not formed into a film. The cathode mixture according to Test Example 4 uses a binder having the property of not forming a film, which is not generally used in the film formation process, which suggests that a binder having the property of not forming a film can be identified based solely on the flow index. Here, the binder having the property of not forming a film indicates a binder which is not fibrillized due to a lack of energy supply necessary for fibrillization during mixing.

As described above, for a cathode mixture having a flow index in a range of 0.50 and 0.70, it can be determined that the mixture will be formed into a film regardless of the ratio of electrode materials or mixing conditions.

TABLE 2

| | Ratio of | | | | |
|---|---|---|---|---|---|
| | electrode | Dispersion | | | |
| Test | materials | condition | Fitted | Flow | Film |
| example | (wt %) | (RPM) | value | index | formation |
| 1 | 96:2:2 | 2000 | 0.2824 | 0.24 | X |
| 2 | 96:2:2 | 3000 | 0.2047 | 0.20 | X |
| 3 | 96:2:2 | 4000 | 0.6727 | 0.69 | ◯ |
| 4 | 96:2:2 | 4000 | 0.2557 | 0.23 | X |
| | (use of binder 1) | | | | |
| 5 | 96:2:2 | 4000 | 0.5622 | 0.58 | ◯ |
| | (use of binder 2) | | | | |
| 6 | 97:1:2 | 2000 | 0.2748 | 0.24 | X |
| 7 | 97:1:2 | 3000 | 0.2792 | 0.24 | X |
| 8 | 97:1:2 | 4000 | 0.6355 | 0.65 | ◯ |
| 9 | 97:2:1 | 2000 | 0.2270 | 0.21 | X |
| 10 | 97:2:1 | 3000 | 0.2666 | 0.23 | X |
| 11 | 97:2:1 | 4000 | 0.6031 | 0.61 | ◯ |

Test examples regarding whether anode mixtures are capable of being formed into films are set forth in Table 3. Here, a ratio of electrode materials indicates a ratio of the sum of both an electrode active material and a conductive material to a binder, i.e., (electrode active material+conductive material):binder. For example, in Test Example 12, 97 indicates the wt % of the sum of the content of the electrode active material and the content of the conductive material, and 3 indicates the wt % of the binder.

In the same manner as the cathode mixtures, it may be confirmed that, when the flow index of a specific anode mixture is within a designated range, it can be confirmed that the corresponding anode mixture is formed into a dry electrode film. However, the flow index range for anode mixtures is different from the flow index range for cathode mixtures. It was confirmed that, when the flow index of an anode mixture is 0.60 to 0.80, the anode mixture is capable of being formed into a dry electrode film, while, when the flow index of a cathode mixture is 0.50 to 0.70, the cathode mixture is capable of being formed into a dry electrode film. Also, it may be determined whether a particular node mixture is capable of being formed into a film only through the flow index of the corresponding anode mixture even though a ratio among electrode materials and dispersion conditions are not known.

TABLE 3

| | Radio among | | | | |
|---|---|---|---|---|---|
| | electrode | Dispersion | | | |
| Test | materials | condition | Fitted | Flow | Film |
| example | (wt %) | (RPM) | value | index | formation |
| 12 | 97:3 | 100 | 0.1407 | 0.12 | X |
| 13 | 97:3 | 500 | 0.1377 | 0.11 | X |
| 14 | 97:3 | 1000 | 0.1376 | 0.11 | X |
| 15 | 97:3 | 1500 | 0.7182 | 0.73 | ◯ |
| 16 | 97:3 | 1500 | 0.1394 | 0.11 | X |
| | (use of binder 1) | | | | |
| 17 | 97:3 | 1500 | 0.1356 | 0.11 | X |
| | (use of binder 2) | | | | |
| 18 | 97:3 | 2000 | 0.7349 | 0.75 | ◯ |
| 19 | 97:3 | 2500 | 0.7475 | 0.76 | ◯ |
| 20 | 98:2 | 2500 | 0.6601 | 0.67 | ◯ |
| 21 | 98.5:1.5 | 2500 | 0.5503 | 0.56 | X |
| 22 | 99:1 | 2500 | 0.5471 | 0.55 | X |

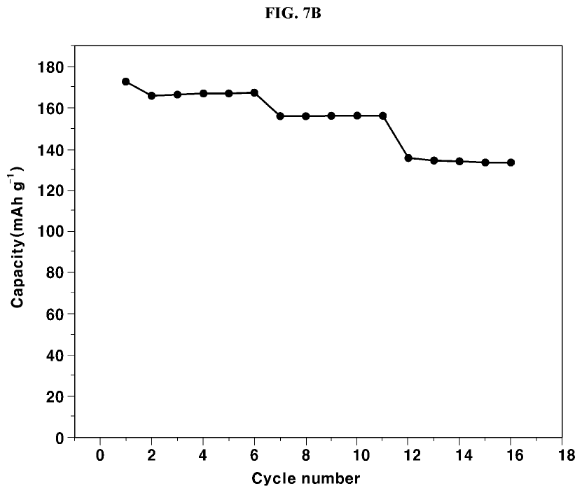

FIGS. 7A and 7B are graphs representing electrochemical test results of a dry electrode for batteries fabricated by the method according to the present disclosure. The dry electrode for cathodes including NMC as an active material was tested using the dry electrode bonded to aluminum foil as a working electrode, and lithium metal as reference and counter electrodes. When the dry electrode was charged to 4.25 V at a charge current of 0.1 C and a cut-off current of 0.05 C in the Constant Current-Constant Voltage (CC-CV) mode, and was discharged at 0.33 C, 1.0 C, and 2.0 C, the dry electrode exhibited capacity equivalent to the capacity of wet electrodes. The thickness of the fabricated dry electrode including a current collector, i.e., aluminum foil, was equal to or less than 800 μm, and the loading density of the dry electrode was equal to or less than 60 milligram per square centimeter (mg/cm²). Referring again to FIG. 3, according to one example of implementation of the present disclosure, when the flow index of the mixture which is subject to evaluation of flow properties is within the predetermined flow index range, the mixture is manufactured into a dry electrode film (S14). On the contrary, when the flow index of the mixture deviates from the predetermined flow index range, the method may return to S10 so that a new mixture is obtained again. According to the present disclosure, feedback may be immediately provided to process lines through evaluation of flow properties of such a half-finished product without a tricky analysis process on a finished mixture.

Referring again to FIG. 1, the mixture of the electrode materials, which meets the reference required for the evaluation of flow properties at S12, goes through the film formation process at S14. When high temperature and high pressure are applied to the mixture through calendaring or pressing, the mixture may be manufactured into a free-standing or self-standing dry electrode film. That is, the dry electrode film is manufactured in a free-standing type which is not torn off and stands on its own. The film formation process may be executed at a temperature of 20 to 180° C., a pressure of 1 to 100 tons, and a speed of 1 to 20 m/mins.

The manufactured dry electrode film is bonded to or laminated with a current collector at S16, and thereby, fabrication of the dry electrode for batteries is completed at S18. Pressing or calendaring may be applied to the lamination of the dry electrode film with the current collector. In order to laminate the dry electrode film with the current collector, the dry electrode film and the current collector may be pressed at a temperature of 20 to 200° C., a pressure of 1 to 100 tons, and a speed of 1 to 20 m/mins. In order to improve adhesion between the dry electrode film and the current collector, the surface of the current collector may be coated with a mixture of a polymer and a carbon-based conductive material.

According to the present disclosure, a dry electrode fabrication process may include a evaluation operation of flow properties of a mixture or a half-finished product, thereby being capable of effectively controlling and managing the quality of a dry electrode.

In the conventional dry electrode film formation process, powder is manufactured, and some amount of the powder is sampled and is measured using an electron microscope. Although whether the powder is capable of being formed into a film or the quality of the powder may be determined through measurement using the electron microscope, a lot of time and cost are taken, and it is difficult to expect immediate feedback to process lines. On the other hand, in the present disclosure, whether the mixture or the half-finished product is capable of being formed into a film may be determined during the fabrication process, thereby greatly reducing time and cost required for quality control and improving the quality of the dry electrode.

As is apparent from the above description, the present disclosure provides a method of fabricating a dry electrode which may effectively control and manage the quality of a half-finished product during a dry electrode fabrication process.

The disclosure has been described in detail with reference to preferred implementations thereof. However, it will be appreciated by those skilled in the art that changes may be made in these implementations without departing from the principles and spirit of the disclosure, the scope of which is defined in the appended claims and their equivalents.

What is claimed is:

1. A method of fabricating a dry electrode, comprising:
preparing a mixture of electrode materials by mixing an electrode active material, a conductive material, and a binder in a predetermined ratio;
obtaining a flow index of the mixture based on a measurement of flow properties; and
determining characteristics of the mixture based on the flow index.

2. The method of claim 1, wherein the characteristics of the mixture comprise a film formation possibility.

3. The method of claim 1, further comprising obtaining a dry electrode film by performing film formation using the mixture based on the characteristics of the mixture satisfying a predetermined condition.

4. The method of claim 3, further comprising fabricating the dry electrode by bonding the dry electrode film to a current collector.

5. The method of claim 1, wherein the flow properties is measured based on American Society for Testing and Materials (ASTM) standard D6128.

6. The method of claim 1, wherein the characteristics of the mixture are determined before the film formation of the mixture.

7. The method of claim 5, wherein obtaining the flow index comprises:
applying a shear stress to the mixture through a tester of flow properties of powder and measuring an internal force of the mixture with respect to the applied shear stress; and
obtaining the flow index by differentiating the measured internal force with respect to the shear stress corresponding to the internal force.

8. The method of claim 1, wherein determining the characteristics of the mixture comprises:
comparing the obtained flow index with a predetermined flow index range; and
determining a film formation possibility of the mixture based on the comparison.

9. The method of claim 8, wherein, based on the obtained flow index being within the predetermined flow index range, the dry electrode film is obtained by performing film formation using the mixture.

10. The method of claim 8, wherein, based on the obtained flow index being outside the predetermined flow index range, returning to preparing the mixture.

11. The method of claim 8, wherein the predetermined flow index range is determined by:
preparing a plurality of mixtures under different mixing conditions, each mixture having a preset ratio of the electrode materials;
measuring flow indexes of each mixture; and
performing a film formation process on the respective mixtures.

12. The method of claim 11, wherein the predetermined flow index range is determined based on whether each mixture is formed into films by the film formation process.

13. The method of claim 8, wherein, based on the mixture being a mixture of electrode materials for cathodes, the predetermined flow index range is 0.50 to 0.70.

14. The method of claim 8, wherein, based on the mixture being a mixture of electrode materials for anodes, the predetermined flow index range is 0.60 to 0.80.

15. The method of claim 1, wherein the mixture of the electrode materials is used to fabricate a dry electrode of a lithium ion battery comprising a liquid electrolyte.

16. The method of claim 1, wherein the mixture of the electrode materials further comprises a solid electrolyte, and the mixture of the electrode materials is used to fabricate a dry electrode of an all-solid-state battery.
